(19) United States
(12) Patent Application Publication
(10) Pub. No.: US 2017/0178144 A1
(43) Pub. Date: Jun. 22, 2017

(54) SYNCHRONIZED COMMUNICATION PLATFORM

(71) Applicant: MMS USA HOLDINGS INC., Boston, MA (US)

(72) Inventors: Christopher Follett, Seattle, WA (US); Eric Campdoras, Seattle, WA (US); PaiFang Su, Seattle, WA (US)

(21) Appl. No.: 15/388,620

(22) Filed: Dec. 22, 2016

Related U.S. Application Data
(60) Provisional application No. 62/270,920, filed on Dec. 22, 2015.

(51) Int. Cl. G06Q 30/00; G06F 17/30; H04L 29/06; G06N 99/00

(52) U.S. Cl. CPC G06Q 30/01; G06N 99/005; G06F 17/30563; H04L 65/403; H04L 65/4015

(57) ABSTRACT

An interactive communication platform may synchronize the display of information between entities who are remotely located from each other. The platform may create a conversation flow between the entities that mimics an in-person experience, but with one of the entities having the support of an artificial intelligence engine to prompt the entity with information card objects to guide the flow in a successful direction. The supported entity's communication may be completely computer-driven such that the other entity interacts either substantially or wholly with a computer system.

### CROSS-REFERENCE TO RELATED APPLICATION

This application claims the benefit of U.S. Provisional Application No. 62/270,920 filed Dec. 22, 2015, the disclosure of which is entirely incorporated herein by reference.

### FIELD OF TECHNOLOGY

The present disclosure relates to a web-based communication platform for facilitating a real-time, synchronized conversation between a consumer and a product/service specialist agent and, in particular, to an interface including graphic “Information Cards” that are presented based on an artificial intelligence engine which helps consumers visualize the discussion through information design and interactivity in a synchronized graphic display environment.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Effective “live” consumer service in an internet context is challenging to implement. Typically, a consumer may initiate a “chat” session with an agent and the parties may communicate with each other via text or video. However, such systems are difficult and costly to maintain when most internet shopping experiences are available 24-hours-a-day.

Amazon Technologies, Inc. offers a video-based support service in the form of the Mayday® button available on a consumer interface of some computing devices. This service allows a consumer to connect to an Amazon Tech advisor who guides the consumer through any feature on the device by drawing on the consumer's screen, walking the consumer through how to perform certain actions, or other service-oriented tasks. While the Mayday® service is more graphically interactive than the typical “chat” solution, the Mayday® interface is designed as a self-service experience where the agent's role is to teach the consumer how to operate the computing device.

### SUMMARY

Features and advantages described in this summary and the following detailed description are not all-inclusive. Many additional features and advantages will be apparent to one of ordinary skill in the art in view of the drawings, specification, and claims hereof. Additionally, other embodiments may omit one or more (or all) of the features and advantages described in this summary.

The apparatuses and methods described herein generally include an interactive communication platform that synchronizes the display of information between remotely located computing devices. An interactive communication platform may synchronize the display of information between entities who are remotely located from each other. The platform may create a conversation flow between the entities that mimics an in-person experience, but with one of the entities having the support of an artificial intelligence engine to prompt the entity with information card objects to guide the flow in a successful direction. The supported entity's communication may be completely computer-driven such that the other entity interacts either substantially or wholly with a computer system. For example, communication with an artificial intelligence system from a consumer computing device may begin with a consumer interacting with an artificial intelligence-driven “conversation” but evolve into an interaction with a live specialist as the system identifies more complex consumer needs. As the system gathers more information from consumer/specialist interactions, the specialist communication with the consumer may be completely computer-driven such that the consumer interacts either substantially or wholly with a computer system.

In some embodiments, the system includes a first graphical user interface (first GUI) on a specialist computing device and a second graphical user interface (second GUI) on a consumer computing device. The first GUI is configured to analyze consumer input, determine, using machine learning or other artificial intelligence techniques, one or more information card graphic objects that respond to the consumer input, present the determined information graphic card objects to a consumer within a dashboard portion of the first GUI, and facilitate communication of at least one of the determined information graphic card objects to the second GUI. The first GUI executing on the specialist computing device may be specifically designed to facilitate the selection and communication of information related to individual service or purchase processes to a second GUI executing at a consumer computing device. In some embodiments, the information cards may be organized, prioritized, or highlighted on the dashboard portion in a manner that helps a specialist using the specialist computing device to configure the service computing device to deliver the right information card graphic object to the second GUI at the consumer computing device at the right moment. In other embodiments, artificial intelligence modules and functions may create information graphic card objects in response to the consumer input for synchronized communication to the specialist and the consumer at the first and second GUIs, respectively.

For example, the dashboard portion of the first GUI may also cause the specialist computing device to utilize artificial intelligence listening processes to assist the specialist in identifying which information card graphic object would be the most useful to a consumer. In some embodiments, an artificial intelligence engine can also compose customized information card graphic objects based on conversational listening in real-time. In use, the embodiments described herein may enhance live and self-service interactions via a synchronized graphic interface between a consumer and product/service specialist with backend artificial intelligence assistance. The embodiments may allow real-time sharing of information card graphic objects between the specialist/backend artificial intelligence and the consumer while being functionally universal and independent of the particular product or service being offered. Further, the embodiments may utilize information design and interactivity to help the consumer visualize a discussion about the product or service. The information card graphic objects may work in combination with each other to simplify complex product or service buying procedures while the consumer may seamlessly transition between self-service modes and live expert advice modes depending on needs.

A synchronized communication platform apparatus or computer-implemented method may employ a memory and a processor disposed in communication with said memory, and configured to issue a plurality of processing instructions stored in the memory. The processor may implement several instructions stored within the memory. For example, in some embodiments, the processor may determine, at the processor and based on a weight value, a plurality of information card graphic objects. The processor may then receive, at a processor of a specialist computing system via a computer network, consumer input data from a remote consumer computing device, wherein the consumer input data includes data describing a product or service. The processor may also determine, at the processor and based on the consumer input data, a subset of the plurality of information card graphic objects and transmit, in response to the consumer input data, an information card object of the subset of the plurality of information card graphic objects to the consumer computing device via the computer network. In further embodiments, the processor may simultaneously display at least a portion of the plurality of information card graphic objects within a first GUI at the specialist computing system and the transmitted information card object of the subset of the plurality of information card graphic objects within a second GUI at the consumer computing device. The weight value may be based at least in part on past transaction data from a data warehouse communicably coupled to the processor. Also, the plurality of information card graphic objects may be displayed within the first GUI at the specialist computing system and describe a series of discrete, sequential steps for informing a consumer about the product or service.

### BRIEF DESCRIPTION OF THE DRAWINGS

FIG. 1 illustrates an exemplary embodiment of an exemplary system for consumer service information management;

FIG. 2 illustrates an exemplary embodiment of graphic user interfaces for use with the system for consumer service information management;

FIG. 3 illustrates one embodiment of a method for use with the system for consumer service information management; and

FIG. 4 illustrates an exemplary computing system for use within the system for consumer service information management.

The figures depict a preferred embodiment for purposes of illustration only. One skilled in the art may readily recognize from the following discussion that alternative embodiments of the structures and methods illustrated herein may be employed without departing from the principles described herein.

### DETAILED DESCRIPTION

Using a computing device, a remotely-located consumer may login to a specialist system using a native or web-based application to initiate a sales or marketing conversation about a product or service. The specialist system may display several information card graphic objects to a specialist that is remotely located from the consumer. The consumer display, however, only shows what the specialist system chooses to share with the consumer computing device. In other words, while having the conversation with the remotely-located consumer, the specialist (e.g., an artificial intelligence driven specialist system or human specialist) may share information from the graphic objects (i.e., “cards”) to a display of the consumer computing device in real time. Only these shared graphic objects are synchronized between the specialist system and the consumer computing device. As the flow progresses, whatever action the consumer takes at the consumer computing device in response to the synchronized graphic objects, the specialist will see at the specialist computing device. This synchronization allows a natural conversation to occur while several information card graphic objects are introduced to the specialist in response to consumer input. The specialist system then selects one of the several cards to progress the conversation flow and assist the consumer in decision making and product/service understanding. The conversation flow may occur using any number of formats including voice, video or text chat, or other communication modes. Whether conversing with a live specialist or an artificial intelligence driven specialist, the system learns from the consumer/specialist interaction to weight certain information card graphic objects more heavily than others based on a variety of factors. For example, weighting may be based on whether the conversation flow results in a successful outcome (i.e., the consumer purchased the product or service), how often a specialist or consumer selects an information card graphic object, and other factors. Those graphic objects that are weighted more heavily than others will be more favored for presentation to the consumer. Eventually, once enough data is collected to determine which information card graphic object is best given consumer input data, consumer demographic data, profile data, etc., the system may execute without interaction with a live specialist, but only by consumer/system interaction.

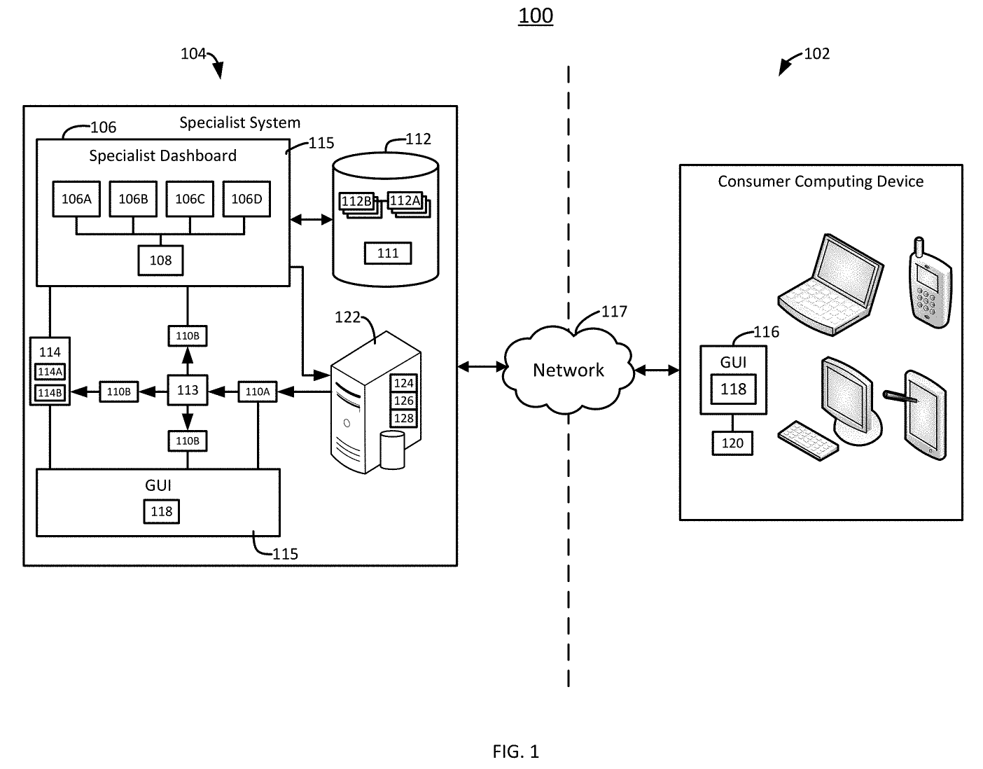

FIG. 1 generally illustrates an embodiment for a system for consumer service information management 100. The system 100 may include front end components 102 (e.g., a consumer computing device) and backend components 104 (e.g., a specialist system) in communication with each other via a communication link 106 (e.g., computer network, internet connection, etc.). The system 100 may include various software or computer-executable instructions and hardware components or modules that may employ the software and instructions to manage the processing, selection, and delivery of consumer service content to potential consumers as described herein. The various modules may be implemented as computer-readable storage memories containing computer-readable instructions (i.e., software) for execution by a processor of the computer system 100 within a specialized computing device. The modules may perform the various tasks associated with the identification, selection, and delivery of product content, consumer service content, and other data, as herein described. The computer system 100 may also include both hardware and software applications, as well as various data communications channels for communicating data between the various front end 102 and back end 104 hardware and software components.

The backend components or specialist system 104 may include one or more instruction modules including a “dashboard” user interface module 106 that, generally, may include instructions to cause a processor 108 to functionally communicate with a plurality of other computer-executable steps or modules 106A, 1068, 106C, and 106D. These modules 106, 106A-D may include instructions that, upon execution by one or more computer processors 108, “learn” which information card graphic objects 112A to send to a consumer. For example, the modules 106, 106A-D may analyze consumer input data 110A while or after it is received from a consumer computing device 102 (e.g., text, voice, or other input) as well as analyze past transaction and other data 111 from a data warehouse 112 and, use artificial intelligence techniques (i.e., an artificial intelligence module 114, as described herein) to determine or create information card graphic objects 112A for display at the specialist system 104. The past transaction and other data 111 may include data indicating a likelihood that one or more of the information card graphic objects 112A may include information that leads to a desired result for the consumer. For example, the past transaction and other data 111 may include a weight value 112B as determined by a learning sub-module 114A as herein described, or as determined by other artificial intelligence techniques. A subset of the group of information card graphic objects 112A may then be transmitted via the network 117 for display at the consumer computing device 102.

The first GUI 115 at the specialist system 104 may also be referred to as a specialist dashboard 115 and the second GUI 116 may be referred to as a consumer GUI 116. In some embodiments, analysis of the consumer input data 110A with or without the past transaction and other data 111 to determine or create the one or more information card graphic objects 112A is performed offline (e.g., during periods when the specialist system 104 is not in synchronous communication with a consumer computing device 102), or when such communication is otherwise not being performed. The modules 106A-D may analyze large datasets of the past transaction and other data 111 resulting in the plurality of information card graphic objects 112A which may also be stored in the data warehouse 112. This set of modules or processes 106A-D can be run occasionally when there is a need to update the system 100 to consider new forms of input 110A or other information.

Generally, the system 104 may use the information card graphic objects 112A to guide a conversation with the consumer computing device 102 in a successful direction. For example, communication with the specialist system 104 from the consumer computing device 102 may begin with a consumer interacting with an artificial intelligence-driven “conversation” but evolve into an interaction with a live specialist as the system 104 identifies more complex consumer needs. As the system 104 gathers more information from consumer/specialist interactions, the specialist communication with the consumer may be completely computer-driven such that the consumer interacts either substantially or wholly with a computer system.

The information card graphic objects 112A may include collections of past transaction and other data 111 that are relevant to a particular purchase/service process. For example, a data collection for the objects 112A may include text, images, video, or other data. A group of the objects 112A may then describe discrete, sequential steps or a “script” for informing a consumer about a product or service. A group of the objects 112A may then be used whenever a specialist wants to inform a consumer about that particular product or process. In some embodiments, the specialist dashboard 115 may display the group of objects 112A corresponding to a particular product or service or a class of products or services in response to the system 104 identifying characteristics of the product or service within the consumer input data 110A received at the system 104. From the identified characteristics, the system 104 may then determine a particular product or service or a class of products or services. In other embodiments, the system 104 may transmit a selection of products or services for display on the consumer GUI 116, from which the consumer computing device 102 may respond with a selection. Initially, the specialist GUI 115 may display objects 112A corresponding to the identified or selected product or service that are most popular or useful to the consumer based on the consumer's selection from a displayed list of possibilities, known sales data for other consumers that match one or more profile, past transaction, demographic characteristics of a current consumer using the system 100, etc. For example, the objects 112A may correspond to a rank-ordered collection of objects 112A describing particular historic services or products or features of services or products that match one or more consumer characteristics or consumer input. The system 100 may rank the objects 112A according to how closely the consumer characteristic or input matches one or more demographic characteristics of other consumers that show affinity or usefulness of the objects 112A. However, once a specialist dashboard 115 is able to “converse” with a consumer, an artificial intelligence module 114, as described below, may re-order and/or highlight the objects 112A or even compose custom objects 112A based on consumer input data 110A or parsed consumer input data 110B. In some embodiments, the various modules as herein described may include instructions to configure a processor to present only those objects 112A which include data that, if presented to the consumer, will keep the service/sales presentation moving forward to culminate in a sale.

In some embodiments, the consumer input data 110A may be received by a recognition module 113. The recognition module 113 may include instructions to parse consumer input data 110A into a format that is usable by other modules of the specialist system 104. For example, where the input data 110A is voice, the module 113 may execute instructions to parse the input data 110A into text or another format to create parsed data 110B that may be used by various modules of the specialist system 104.

The system may also include an artificial intelligence module 114. The artificial intelligence module may include instructions to receive the parsed consumer input data 110B and use that data to influence future conversations using the specialist system. In some embodiments, the artificial intelligence module 114 may include a learning sub-module 114A and an execution sub-module 114B.

The learning sub-module 114A may include instructions to record metadata about the information card graphic objects 112A that are selected by a specialist and/or a consumer during a service/sales presentation to a consumer. For example, the learning module 114A may collect data about the content of each selected object 112A, positioning of the object within the GUI 115 when selected, and other data in relation to the consumer input 110A, 110B. This may allow the artificial intelligence module to execute other instructions which inform the system 100 about the relevance of the pieces of data that make up each information card graphic object 112A toward a successful conversation flow.

Some information the learning sub-module 114A determines may include a weight value 112B or other measure of the importance of an information card graphic object 112A based on how often a particular object 112A or portions of an object 112A correspond to a consumer's desired action (such as a product sale, a service subscription, etc.), how often a specialist and/or a consumer selects the particular object 112A, or other desired outcomes. The learning sub-module 114A may include instructions to modify a weight value 112B to an information card graphic object 112A depending on whether a consumer or a specialist selects the object 112A from the GUI. For example, selection of a particular information card graphic object 112A at the consumer computing device 102 or the specialist computing device 104 which, in turn, results in a desired outcome of the “conversation” may cause the system 100 to assign an increased weight value 112B to that particular card. The execution module 114B may then use the weighted objects 112A determined by the learning module 114A to automatically create synchronized displays of the information card graphic objects 112A within the GUIs 115, 116 without a specialist providing input to the system 104. In some embodiments, the system 104 may employ a neural network or other AI system to automatically provide an information card graphic object 112A in response to consumer input data.

Success rates may also be used by the module 114 to determine the weight value 112B value or other measure of correlation to the information card graphic object 112A or portions of the objects 112A. This determined weight value 112B may then be used to select which object 112A or portions of the objects 112A may be synchronously displayed within the GUIs of the system 100 to achieve a desired outcome based on the received consumer input data 110A. For example, a weight value 112B may be represented by a number that is higher for information card graphic objects 112A or portions of the objects 112A that are more often associated with a desired outcome than not. A weight value 112B assigned to an information card graphic object 112A may correspond to several categories or sources. In some embodiments, the weight value 112B may be determined from the use of each information card graphic object 112A during a presentation, a timing or sequence for use of each information card graphic object 112A during a presentation, consumer interaction with each card or an input to the system provided by the consumer, a specialist interaction with the consumer as related to each information card graphic object 112A, and a measure of an interaction between the consumer and the specialist with a larger community of consumers and specialists.

The weights 1128 for each corresponding object 112A may change over time based on a variety of factors. For example, where a large sample of consumers or specialists selects a particular object 112A, the weight value 112B associated with that card object 122A may increase or decrease to signify its importance toward a particular desired result (i.e., a sale, or other goal for the system 104). In such a way, the weighting process may resemble a “community” or decisions to form a tree-like presentation that represents the best sequence of information card graphic objects 112A for each consumer based on a variety of factors from the consumer input data 110A and other data. Too, an administrator of the system 104 may override the weighting process that is based on consumer or specialist selection during a live interaction. In some embodiments, a specialist overriding may include assigning a weight value 112B to an object 112A.

The learning sub-module 114A may also include instructions to record actions during presentation of one or more information card graphic objects 112A to a consumer. For example, the module 114A may include an instruction to record the selection at one or more of the consumer computing device 102 or the specialist system 104. Further, the module 114A may include an instruction to assign a weight value 112B to the object 112A based on the selection at one or more of the consumer computing device 102 or the specialist system 104. The learning sub-module 114A may also include instructions to record actions and weights 1128 at other times. For example, actions at the consumer computing device 102 may be “batched” or recorded within the data warehouse 112 after communication of one or more information card graphic objects 112A has taken place. The batching process may occur periodically (e.g., hourly, daily, weekly, etc.). actions during presentation of one or more information card graphic objects 112A to a consumer.

Further, the module 114 may include instructions to configure one or more processors 108 to prioritize the information card graphic objects 112A or highlight which of the information card graphic objects 112A would be the most useful to a consumer according to the determined weight value 112B. The module 114 may also include instructions to configure a processor to compose customized information card data objects 112A based on the parsed consumer input data 110B. Substantially, the interaction between the artificial intelligence module 114, the recognition module 113, and information contained within the various information card graphic objects 112A allows the system 104 to “listen” and process the consumer input data 110A in real-time to create synchronized displays of the information card graphic objects.

Each weight value for an information card graphic object 112A or portions of the objects 112A may be determined by a number of factors, as well. For example, in some embodiments, the weight may be determined by an order of the presentation for a plurality of information card graphic objects 112A, a progression of several objects 112A (i.e., a particular progression that leads to a successful outcome may receive a higher weight than one that is not as successful), how often an information card graphic object 112A results in a consumer exiting the conversation flow, a popularity of the information card graphic object 112A (e.g., from a consumer rating or how often the object results in a successful outcome), the success of different variants of an information card graphic object 112A, how long a consumer remains engaged after presenting a particular information card graphic object 112A, and a rate at which an information card graphic object 112A is saved or shared by the specialist to the consumer.

The system 100 may also monitor several different metrics corresponding to the consumer while using the system to determine weight values for each information card graphic object 112A. For example, the system 100 may record profile or demographic information about the consumer (e.g., name, contact information, gender, age, income, etc.) as well as the product or service currently being offered by the system 100 during the consumer interaction. Likewise, the system 100 may solicit a rating from the consumer for each information card graphic object 112A presented or for particular segments of the presentation. The system 100 may also track an engagement time with the consumer for each information card graphic object 112A (e.g., how long a consumer views or otherwise considers information presented by an information card graphic object 112A) as well as a consumer's response to information presented by one or more objects 112A and a number of the information card graphic objects 112A the consumer views. Importantly, the system 100 tracks whether a consumer ultimately buys a product or service and weights each card involved in this successful transaction accordingly.

The system may also monitor several different metrics for actions taken with the specialist system 104 to determine weight values. For example, the system 100 may monitor or determine a relationship between a question received from a consumer and an information card graphic object 112A presented in response to that question. Where presentation of an object 112A in response to a consumer question results in a completed transaction, the presentation order of the objects 112A may be recorded and used as well as an amount of time an agent spends with a consumer or information card graphic object 112A in response to a consumer interaction with the specialist system 104. Further, an specialist rating value may contribute to weight values and, ultimately, this information may be used by the artificial intelligence module to determine presentation order, time, and other values associated with the information card graphic objects 112A. Variants of each information card graphic object 112A such as different speaking notes or other types of information presented to the specialist may also contribute to the weight to determine how to respond to consumer input to the specialist system and other information.

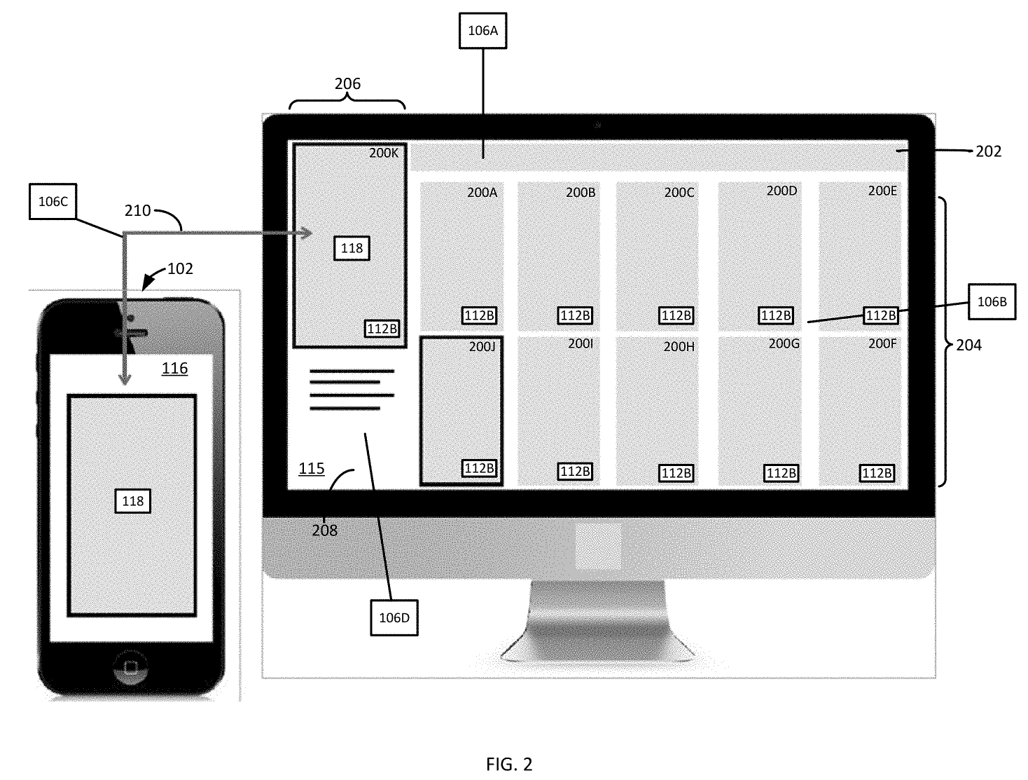

With reference to FIGS. 1 and 2, the specialist dashboard module 106 may include a plurality of sub-modules. For example, a navigation module 106A may include instructions to configure the processor 108 to display different categories and select different functions within a navigation pane 202 (FIG. 2) of a specialist GUI 115. A cards module 1068 may display available information card graphic objects 112A within a cards portion 204 of the GUI 115, with each of the displayed objects 112A able to be shared in real-time onto a consumer GUI 116 via the network 117 from a sharing area 206 of the specialist GUI 115. A synchronized share module 106C may include instructions to configure the processor 108 to display synchronized information 118 (e.g., information card graphic objects 112A) that a specialist and consumer both see via GUI 115 and GUI 116, respectively, within the sharing area 206. A speaking notes module 106D may include instructions to display text or other information within a speaking notes area 208 of the specialist GUI 115 to provide context to the synchronized information 118.

The consumer GUI 116 may include a module 120 (FIG. 1) having instructions to configure a processor to implement a plurality of experience modes for the GUI 116. In some embodiments, the module 120 includes instructions to present a self-service mode which presents a series of information card graphic objects 200A-K including high-level product or service information and interactivity that the consumer accesses without incorporating instructions from the artificial intelligence module 114. Further embodiments of the module 120 may include an artificial Intelligence mode which executes instructions to configure a processor to pass parsed data 110B to the artificial intelligence module 114. In the artificial intelligence mode, the GUI 116 may also receive a response to the parsed input 110B from the specialist system 104 via the network 106. In some embodiments, the particular response may be selected based on training the artificial intelligence module 114 via interaction with one or more human specialists for a period of time using the learning module 114A. For example, success rates may indicate which of the objects 112A include data that, upon presentation to a consumer, are more successful given the particular consumer input data 110A. The artificial intelligence module 114 may include instructions to configure a processor to find one or more universal rule sets that, no matter what product or service is the subject of the interaction between the front end components and backend components, when compared to the consumer input data 110A, one or more rules may indicate one or more information card graphic objects 112A that include data to give the consumer exactly what he or she wants. Once trained, the artificial intelligence module 114 may include instructions to configure a processor to select a particular response autonomously. Some categories for input to the rule sets may include historical data indicating information that has resulted in a completed transaction with a consumer, “A, B, C” testing to change various features presented to the consumer to find an optimal combination, also allowing a specialist to indicate which of the various objects 112A are successful, and also a combination of specialist and consumer input to determine which data presented to the consumer from the various objects is most successful. In still further embodiments of the module 120, a specialist mode may cause the consumer input data 110A to be viewed by a specialist who selects and communicates data from an information card graphic object 200A-K to the GUI 116.

FIG. 2 generally illustrates an embodiment of both the dashboard GUI 115 and the consumer GUI 116. The dashboard GUI 115 may display a plurality of information card graphic objects 112A, illustrated in FIG. 2 as information card graphic objects 200A-K. Each of the information card graphic objects 200A-K may have two states: a presentation state which may include instructions to present information within the dashboard GUI 115, and a selection state which may be used to make a decision once presented in the consumer GUI 115. Each information card graphic object 200A-K may include talking points that a specialist may use to provide verbal context and that, upon selection of a particular information card graphic object 200K that is placed within the sharing area 206, such text appears within the text area 208. In combination, the object 200A-K may form a sale script for a product or service.

A specialist may share the information card graphic objects 200A-K from the dashboard GUI 115 which may also include design elements that are relevant to the particular purchase/service process described by text within the information card graphic objects 200A-K. In some embodiments, one or more modules (e.g., 106A-D, 114, of FIG. 1, etc.) may include instructions to configure a processor to organize the objects 200A-K on the dashboard GUI 115 in a manner that helps the specialist using the GUI 115 deliver the right card at the right moment. In some embodiments, the artificial intelligence module 114 may identify one or more of the information card graphic objects 200A-J based on the consumer input data 110A or parsed consumer input data 110B. For example, the module may include one or more instructions which configure the processor to identify which object 200A-J would be the most useful to the consumer. Further, the artificial intelligence module 114 may include instructions to configure a processor to compose customized information card graphic objects based on conversational listening to the consumer input data 110A or parsed consumer input data 110B in real-time.

In some embodiments, the consumer GUI 116 may also include various functions or modules to facilitate the shared interaction between the frontend components 102 and the backend components 104. For example, the GUI 116 may include instructions to configure a processor to display a directory icon and connection button across the top of the GUI 116. The GUI 116 may also include instructions to configure a processor to display a synchronized share portion generally in the middle of the GUI 116, which displays one or more portions of the shared information card graphic object 200K (e.g., a graphic portion, a text portion, an interactive portion, a video portion, etc.). Further, the GUI 116 may also include instructions to configure a processor to display a text or voice input field generally at the bottom of the GUI 116. In some embodiments, the text or voice input field may include instructions to configure the processor to retrieve one or more information card graphic objects 220A-K in a self-service mode.

Various entities at the back end 104 may communicate information card graphic objects 112A and other data to the front end components 102 via the computer network 106 using various modules of the system 100. Front end components may include various computing devices 118 such as a personal computer, smart phone, tablet computer, or other suitable computing or mobile device. Each device may include a display for presenting the consumer GUI 116 and may communicate with the specialist system 104 through the Internet 106 and/or other type of suitable network (local area network (LAN), a metropolitan area network (MAN), a wide area network (WAN), a mobile, a wired or wireless network, a private network, a virtual private network, etc.). The network 106 may facilitate any type of data communication via any standard or technology (e.g., GSM, CDMA, TDMA, WCDMA, LTE, EDGE, OFDM, GPRS, EV-DO, UWB, Wi-Fi, IEEE 802 including Ethernet, WiMAX, and/or others).

In some embodiments, the specialist system/back end components 104 in general and a server 122 in particular may include computer-executable instructions 124 stored within a memory 126 of the server 122 and/or executed using a processor 128 to create a specialized computing device. The instructions 124 may instantiate other objects or modules and cause the system to determine and present data within the sharing area 206 on both the specialist GUI 115 and the consumer GUI 116. In some embodiments, the modules described herein and/or other elements of the system 100 may be implemented at least partially on the server 122 and/or the front end components 102. The specialist system 104 and/or processor 128 may execute instructions 124 to determine, share, and display text, images, video, or other data within the GUIS 115, 116.

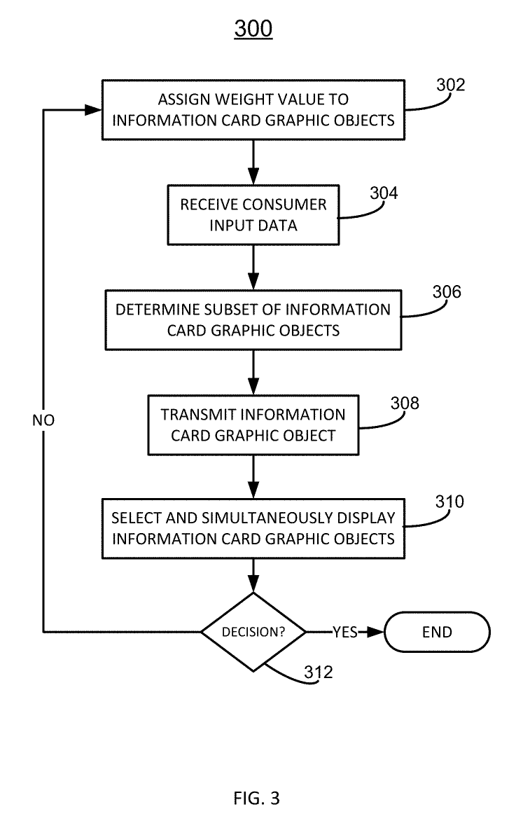

With reference to FIG. 3, the modules, instructions, functions, etc., may also be embodied as a method 300 or various steps or function blocks of a method. Each various function block or instruction described herein may correspond to one or more computer-executable instructions of the modules (e.g., 106A-D, 113, 114, 120, etc.) as executed on one or more processors such as processor 108, 128, etc. Steps executed by the specialist system 104 or the consumer computing device 102 may include various steps. In some embodiments, a computer-implemented method 300 may use artificial intelligence to guide a synchronously-displayed conversation via a series of information card graphic objects 112A transmitted from a specialist computing system 104 to a consumer computing device 102. The specialist system 104 may assign a weight 112B to each of the objects 112A. The weight 112B may then determine how each object 112A is selected for transmission based on a variety of factors including consumer input data 110A, a frequency of selection by one or more of the specialist computing device 104 and the consumer computing device 102, statistical measures, and other factors.

At block 302, the system 100 may assign a weight value 112B to the information card graphic objects 112A. In some embodiments, the method 300 may assign or modify a weight value 112B corresponding to one or more information card graphic objects 112A. For example, the method 300 may execute one or more of the instructions described in relation to the learning module 114A, as herein described.

At block 304, the system 100 may receive consumer input data 110A and, at block 306, determine a subset of the plurality of information card graphic objects 112A from that were previously determined at block 302 based, at least in part, on the received customer input data 110A. For example, the method 300 may execute instructions to analyze consumer input data 110A while or after it is received from a consumer computing device 102 (e.g., text, voice, or other input) as well as analyze past transaction and other data 111 from a data warehouse 112 and, use artificial intelligence techniques (i.e., an artificial intelligence module 114, as described herein) to determine or create information card graphic objects 112A for display at the specialist system 104. The past transaction and other data 111 may be analyzed to indicate a likelihood that one or more of the information card graphic objects 112A may include information that leads to a desired result for the consumer. For example, the past transaction and other data 111 may indicate a weight value 112B as determined by a learning sub-module 114A as herein described, or as determined by other artificial intelligence techniques.

At block 308, the method 300 may execute an instruction to transmit the subset of the group of information card graphic objects 112A via the network 117 for display at the consumer computing device 102, as described herein.

At block 310, the method 300 may execute an instruction to simultaneously display at least one information graphic card object 112A from the subset determined at block 306. In some embodiments, a display at the specialist computing system (e.g., the specialist dashboard 115) may display a number of information card graphic objects 112A that correspond to the highest weights 1128 based on the received consumer input data 110A. With brief reference to FIG. 2, the dashboard 115 may display ten or more information graphic card objects 112A of the subset determined at block 306 and, in some embodiments, the objects 200A-K may also be displayed with the corresponding weight 112B to indicate to a live specialist which object 112A the system 104 has weighted most heavily. An object 112A may then be selected by either a live specialist or the system 104 and displayed within the consumer GUI 116 without the weight 112B also displayed.

If, at block 312, the method 300 determines that the system 104 has received a decision at the specialist computing device 104 from the consumer computing device 102 based on the displayed information card graphic objects 112A, then the method 300 may pass control to any systems to complete the decision transaction and terminate. If, however, the method 300 determines that the system 104 has not received a decision, then the method 300 may repeat.

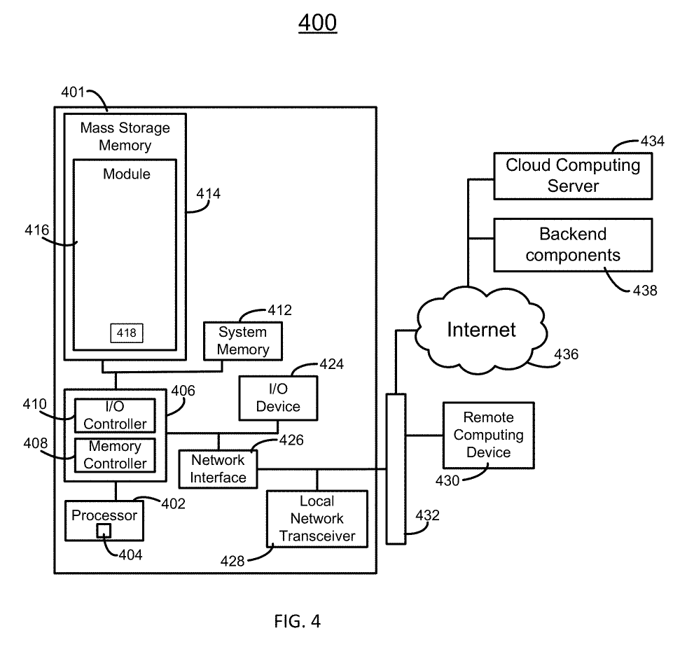

FIG. 4 is a high-level block diagram of an example computing environment 400 for the system (e.g., system 100) and methods (e.g., method 300) for facilitating a conversation between a consumer and a product/service specialist agent having a computing device 401 that may be used to implement the modules and system (100) described herein. The computing device 501 may include a server, a mobile computing device (e.g., a cellular phone, a tablet computer, a Wi-Fi-enabled device or other personal computing device capable of wireless or wired communication), a thin client, or other known type of computing device. As will be recognized by one skilled in the art, in light of the disclosure and teachings herein, other types of computing devices can be used that have different architectures. Processor systems similar or identical to the example systems and methods for facilitating a conversation between a consumer and a product/service specialist agent may be used to implement and execute the example system of FIG. 1, and the interfaces of FIG. 2. Although the example system 400 is described below as including a plurality of peripherals, interfaces, chips, memories, etc., one or more of those elements may be omitted from other example processor systems used to implement and execute the example system for facilitating a conversation between a consumer and a product/service specialist agent. Also, other components may be added.

As shown in FIG. 3, the computing device 401 includes a processor 402 that is coupled to an interconnection bus. The processor 402 includes a register set or register space 404, which is depicted in FIG. 3 as being entirely on-chip, but which could alternatively be located entirely or partially off-chip and directly coupled to the processor 402 via dedicated electrical connections and/or via the interconnection bus. The processor 402 may be any suitable processor, processing unit or microprocessor. Although not shown in FIG. 3, the computing device 401 may be a multi-processor device and, thus, may include one or more additional processors that are identical or similar to the processor 402 and that are communicatively coupled to the interconnection bus.

The processor 402 of FIG. 3 is coupled to a chipset 406, which includes a memory controller 408 and a peripheral input/output (I/O) controller 410. As is well known, a chipset typically provides I/O and memory management functions as well as a plurality of general purpose and/or special purpose registers, timers, etc. that are accessible or used by one or more processors coupled to the chipset 406. The memory controller 408 performs functions that enable the processor 402 (or processors if there are multiple processors) to access a system memory 412 and a mass storage memory 414, that may include either or both of an in-memory cache (e.g., a cache within the memory 412) or an on-disk cache (e.g., a cache within the mass storage memory 414).

The system memory 412 may include any desired type of volatile and/or non-volatile memory such as, for example, static random access memory (SRAM), dynamic random access memory (DRAM), flash memory, read-only memory (ROM), etc. The mass storage memory 414 may include any desired type of mass storage device. For example, if the computing device 401 is used to implement a module 416 (e.g., the various modules to facilitate a conversation between a consumer and a product/service specialist agent and other modules as herein described). The mass storage memory 414 may include a hard disk drive, an optical drive, a tape storage device, a solid-state memory (e.g., a flash memory, a RAM memory, etc.), a magnetic memory (e.g., a hard drive), or any other memory suitable for mass storage. As used herein, the terms module, block, function, operation, procedure, routine, step, and method refer to tangible computer program logic or tangible computer executable instructions that provide the specified functionality to the computing device 401 and the system 100. Thus, a module, block, function, operation, procedure, routine, step, and method can be implemented in hardware, firmware, and/or software. In one embodiment, program modules and routines are stored in mass storage memory 414, loaded into system memory 412, and executed by a processor 402 or can be provided from computer program products that are stored in tangible computer-readable storage mediums (e.g. RAM, hard disk, optical/magnetic media, etc.).

The peripheral I/O controller 410 performs functions that enable the processor 402 to communicate with a peripheral input/output (I/O) device 424, a network interface 426, a local network transceiver 428, (via the network interface 426) via a peripheral I/O bus. The I/O device 424 may be any desired type of I/O device such as, for example, a keyboard, a display (e.g., a liquid crystal display (LCD), a cathode ray tube (CRT) display, etc.), a navigation device (e.g., a mouse, a trackball, a capacitive touch pad, a joystick, etc.), etc. The I/O device 424 may be used with the module 416, etc., to receive data from the transceiver 428, send the data to the backend components of the system 100, and perform any operations related to the methods as described herein. The local network transceiver 428 may include support for a Wi-Fi network, Bluetooth, Infrared, or other wireless data transmission protocols. In other embodiments, one element may simultaneously support each of the various wireless protocols employed by the computing device 401. For example, a software-defined radio may be able to support multiple protocols via downloadable instructions. In operation, the computing device 401 may be able to periodically poll for visible wireless network transmitters (both cellular and local network) on a periodic basis. Such polling may be possible even while normal wireless traffic is being supported on the computing device 401. The network interface 426 may be, for example, an Ethernet device, an asynchronous transfer mode (ATM) device, an 802.11 wireless interface device, a DSL modem, a cable modem, a cellular modem, etc., that enables the system 100 to communicate with another computer system having at least the elements described in relation to the system 100.

While the memory controller 408 and the I/O controller 410 are depicted in FIG. 3 as separate functional blocks within the chipset 406, the functions performed by these blocks may be integrated within a single integrated circuit or may be implemented using two or more separate integrated circuits. The computing environment 400 may also implement the module 416 on a remote computing device 430. The remote computing device 430 may communicate with the computing device 401 over an Ethernet link 432. In some embodiments, the module 416 may be retrieved by the computing device 401 from a cloud computing server 434 via the Internet 436. When using the cloud computing server 434, the retrieved module 416 may be programmatically linked with the computing device 401. The module 416 may be a collection of various software platforms including artificial intelligence software and document creation software or may also be a Java® applet executing within a Java® Virtual Machine (JVM) environment resident in the computing device 401 or the remote computing device 430. The modeling module 420 and the execution module 422 may also be “plug-ins” adapted to execute in a web-browser located on the computing devices 401 and 430. In some embodiments, the module 416 may communicate with back end components 438 such as the backend components 104 of FIG. 1 via the Internet 436.

The system 400 may include but is not limited to any combination of a LAN, a MAN, a WAN, a mobile, a wired or wireless network, a private network, or a virtual private network. Moreover, while only one remote computing device 430 is illustrated in FIG. 3 to simplify and clarify the description, it is understood that any number of client computers are supported and can be in communication within the system 400.

Additionally, certain embodiments are described herein as including logic or a number of components, modules, or mechanisms. Modules may constitute either software modules (e.g., code or instructions embodied on a machine-readable medium or in a transmission signal, wherein the code is executed by a processor) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments” or “an embodiment” or “teaching” means that a particular element, feature, structure, or characteristic described in connection with the embodiment is included in at least one embodiment. The appearances of the phrase “in some embodiments” or “teachings” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Further, the figures depict preferred embodiments of a synchronized selling platform for purposes of illustration only. One skilled in the art will readily recognize from the following discussion that alternative embodiments of the structures and methods illustrated herein may be employed without departing from the principles described herein

Upon reading this disclosure, those of skill in the art will appreciate still additional alternative structural and functional designs for the systems and methods described herein through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the systems and methods disclosed herein without departing from the spirit and scope defined in any appended claims.

1. A synchronized communication platform apparatus, comprising:
a memory; and
a processor disposed in communication with said memory, and configured to issue a plurality of processing instructions stored in the memory, wherein the processor issues instructions to:
determine, at the processor and based on a weight value, a plurality of information card graphic objects;
receive, at a processor of a specialist computing system via a computer network, consumer input data from a remote consumer computing device, wherein the consumer input data includes data describing a product or service;
determine, at the processor and based on the consumer input data, a subset of the plurality of information card graphic objects;
transmit, in response to the consumer input data, an information card object of the subset of the plurality of information card graphic objects to the consumer computing device via the computer network; and
simultaneously display at least a portion of the plurality of information card graphic objects within a first GUI at the specialist computing system and the transmitted information card object of the subset of the plurality of information card graphic objects within a second GUI at the consumer computing device;
wherein the weight value is based at least in part on past transaction data from a data warehouse communicably coupled to the processor and the plurality of information card graphic objects displayed within the first GUI at the specialist computing system describes a series of discrete, sequential steps for informing a consumer about the product or service.

2. The apparatus of claim 1, wherein the instruction to determine the subset of the plurality of information card graphic objects further includes an instruction to determine characteristics of the product or service within the received consumer input data.

3. The apparatus of claim 2, wherein the weight value is based on one or more of a frequency of use for each information card graphic object in the sequential steps for informing the consumer about the product or service, a sequence for use of each information card graphic object during the sequential steps, and further consumer input data received after executing the instruction to transmit the subset of the plurality of information card graphic objects to the consumer computing device via the computer network.

4. The apparatus of claim 3, wherein the instruction to determine the subset of the plurality of information card graphic objects further includes an instruction to modify the weight value for one or more of the plurality of information card graphic objects based on one or more of the consumer input data, a selection of one or more of the plurality of information card graphic objects, and a number of times each of the plurality of information card graphic objects corresponds to a sale of the product or service.

5. The apparatus of claim 4, wherein the instruction to determine the subset of the plurality of information card graphic objects further includes an instruction to record metadata corresponding to information card graphic objects that were selected in past transactions.

6. The apparatus of claim 5, wherein the metadata includes one or more of content and positioning within the first GUI of the information card graphic objects that were selected in past transactions.

7. The apparatus of claim 6, wherein the instruction to simultaneously display the plurality of information card graphic objects within the first GUI at the specialist computing system and the transmitted information card object of the subset of the plurality of information card graphic objects within the second GUI at the consumer computing device further includes an instruction to rank order the subset of the plurality of information card graphic objects based on the weight value.

8. The apparatus of claim 1, wherein the consumer input data further includes demographic data corresponding to the customer.

9. The apparatus of claim 8, further comprising an instruction to compose an information card graphic object based on the received consumer input data.

10. The apparatus of claim 1, wherein the instruction to simultaneously display at least a portion of the plurality of information card graphic objects within the first GUI at the specialist computing system and the transmitted information card object of the subset of the plurality of information card graphic objects within the second GUI at the consumer computing device includes a further instruction to display a presentation state of the transmitted information card object at the first GUI and a selection state of the transmitted information card object at the second GUI.

11. A processor-implemented method of displaying synchronized information between two remote computing devices comprising:
determining, based on a weight value, a plurality of information card graphic objects;
receiving consumer input data from a remote consumer computing device, wherein the consumer input data includes data describing a product or service;
determining, based on the consumer input data, a subset of the plurality of information card graphic objects;
transmitting an information card object of the subset of the plurality of information card graphic objects to the consumer computing device via the computer network; and
simultaneously displaying at least a portion of the plurality of information card graphic objects within a first GUI at the specialist computing system and the transmitted information card object of the subset of the plurality of information card graphic objects within a second GUI at the consumer computing device;
wherein the weight value is based at least in part on past transaction data and the plurality of information card graphic objects displayed within the first GUI at the specialist computing system describes a series of discrete, sequential steps for informing a consumer about the product or service.

12. The computer-implemented method of claim 11, wherein determining the subset of the plurality of information card graphic objects further includes determining characteristics of the product or service within the received consumer input data.

13. The computer-implemented method of claim 12, wherein the weight value is based on one or more of a frequency of use for each information card graphic object in the sequential steps for informing the consumer about the product or service, a sequence for use of each information card graphic object during the sequential steps, and further consumer input data received after executing the instruction to transmit the subset of the plurality of information card graphic objects to the consumer computing device via the computer network.

14. The computer-implemented method of claim 13, wherein determining the subset of the plurality of information card graphic objects further includes modifying the weight value for one or more of the plurality of information card graphic objects based on one or more of the consumer input data, a selection of one or more of the plurality of information card graphic objects, and a number of times each of the plurality of information card graphic objects corresponds to a sale of the product or service.

15. The computer-implemented method of claim 14, wherein determining the subset of the plurality of information card graphic objects further includes recording metadata corresponding to information card graphic objects that were selected in past transactions.

16. The computer-implemented method of claim 15, wherein the metadata includes one or more of content and positioning within the first GUI of the information card graphic objects that were selected in past transactions.

17. The computer-implemented method of claim 16, wherein simultaneously displaying the plurality of information card graphic objects within the first GUI at the specialist computing system and the transmitted information card object of the subset of the plurality of information card graphic objects within the second GUI at the consumer computing device further includes rank ordering the subset of the plurality of information card graphic objects based on the weight.

18. The computer-implemented method of claim 11, wherein the consumer input data further includes demographic data corresponding to the customer.

19. The computer-implemented method of claim 18, further comprising composing an information card graphic object based on the received consumer input data.

20. The computer-implemented method of claim 11, wherein simultaneously displaying at least a portion of the plurality of information card graphic objects within the first GUI at the specialist computing system and the transmitted information card object of the subset of the plurality of information card graphic objects within the second GUI at the consumer computing device includes a further instruction to display a presentation state of the transmitted information card object at the first GUI and a selection state of the transmitted information card object at the second GUI.
